(19) United States
(12) Patent Application Publication
(10) Pub. No.: US 2013/0100273 A1
(43) Pub. Date: Apr. 25, 2013

(54) MICROSCOPE APPARATUS

(71) Applicant: Olympus Corporation, Tokyo (JP)

(72) Inventor: Toshiyuki HATTORI, Tokyo (JP)

(73) Assignee: OLYMPUS CORPORATION, Tokyo (JP)

(21) Appl. No.: 13/652,784

(22) Filed: Oct. 16, 2012

(30) Foreign Application Priority Data
Oct. 19, 2011 (JP) 2011-229849

(51) Int. Cl. H04N 7/18

(52) U.S. Cl. 348/79; 348/E07.085

(57) ABSTRACT

A microscope apparatus includes a λ stack image data acquisition unit that detects light emitted composed of a sample for each wavelength to acquire λ stack image data from multiple image data items for multiple different wavelengths; a spectrum generation unit that generates a spectrum for each pixel based on the λ stack image data; a clustering unit that performs clustering of the spectrum for each pixel into multiple clusters; a color setting unit that sets different colors to the clusters; and an image generation unit that generates an image of the sample by displaying pixels included in the clusters with a color set by the color setting unit. The distribution and gray scale of fluorescent materials within the sample can be correctly recognized and the state of a desired tissue can be favorably observed.

### BACKGROUND OF THE INVENTION

1. Field of the Invention

The present invention relates to a microscope apparatus.

2. Description of Related Art

Heretofore, a microscope apparatus is known. In the microscope apparatus, excitation light for exciting fluorescent materials is applied to a sample coated with fluorescent materials such as fluorescent protein or fluorescent pigment. The fluorescence emitted from the sample is detected for each pixel to acquire brightness information, and an image is generated based on the brightness information, to thereby observe the sample. In recent years, in such a microscope apparatus, λ stack data having wavelength characteristics, such as spectra, is acquired from the fluorescence emitted from the sample (fluorescent materials) for each pixel, and an image is generated based on the λ stack data.

This λ stack data is superior in terms of a large amount of information and allowing observation of a change in wavelength. On the contrary, various contrivances for effectively browsing information are required. For example, U.S. Pat. No. 7,009,699 discloses a technique in which colors each having a highest brightness are allocated and synthesized to pixels from spectra for each pixel.

### BRIEF SUMMARY OF THE INVENTION

However, when an image of a sample is generated by allocating colors each having a highest brightness from spectra for pixels as disclosed in U.S. Pat. No. 7,009,699, if a difference in density of fluorescent materials within the sample is large, the fluorescence emitted from fluorescent materials having a low density does not appear on the image. Accordingly, for example, when different tissues are superimposed on a specific location of the sample, the density of the fluorescence emitted from a desired tissue is low, which makes it difficult to recognize the tissue in the generated image.

The present invention has been made in view of the above-mentioned circumstances, and it is an object of the present invention to provide a microscope apparatus capable of correctly recognizing the distribution and gray scale of fluorescent materials within a sample and favorably observing the state of a desired tissue even when a difference in density of the florescent materials within the sample is large.

To achieve the above-described object, the present invention provides the following units.

One aspect of the present invention is a microscope apparatus including: a λ stack image data acquisition unit that detects light emitted from a sample for each wavelength to acquire λ stack image data including a plurality of image data items for a plurality of different wavelengths; a spectrum generation unit that generates a spectrum for each pixel based on the λ stack image data; a clustering unit that performs clustering of the spectrum for each pixel into a plurality of clusters; a color setting unit that sets different colors to the respective clusters; and an image generation unit that generates an image of the sample by displaying each pixel included in the clusters with a color set by the color setting unit.

In the above-described aspect, the microscope apparatus preferably includes a density setting unit that sets a brightness of each pixel to each pixel included in the clusters according to a value of a maximum brightness among the spectra for each pixel.

In the above-described aspect, the microscope apparatus preferably includes a cluster specifying unit that specifies any cluster among the plurality of clusters, and a spectrum output unit that outputs the spectrum for each pixel included in the cluster specified by a cluster specifying unit.

In the above-described aspect, the microscope apparatus preferably includes an average spectrum calculation unit that calculates an average spectrum of the spectra for all pixels included in the cluster specified by the cluster specifying unit, and the output unit preferably outputs the average spectrum calculated by the average spectrum calculation unit.

### BRIEF DESCRIPTION OF THE SEVERAL VIEWS OF THE DRAWINGS

FIG. 1 is a block diagram illustrating a schematic configuration of a microscope apparatus according to an embodiment of the present invention;

FIGS. 2A and 2B are schematic diagrams each showing A stack image data and spectrum data;

FIGS. 3A and 3B are explanatory views for comparing an image of a sample generated by a microscope apparatus of a related art with an image of a sample generated by a microscope apparatus according to an embodiment of the present invention; and

FIG. 4 is a flowchart illustrating a process for acquiring an image of a sample by the micro apparatus according to an embodiment of the present invention.

### DETAILED DESCRIPTION OF THE INVENTION EMBODIMENTS

A microscope apparatus 100 according to an embodiment of the present invention will be described with reference to the drawings.

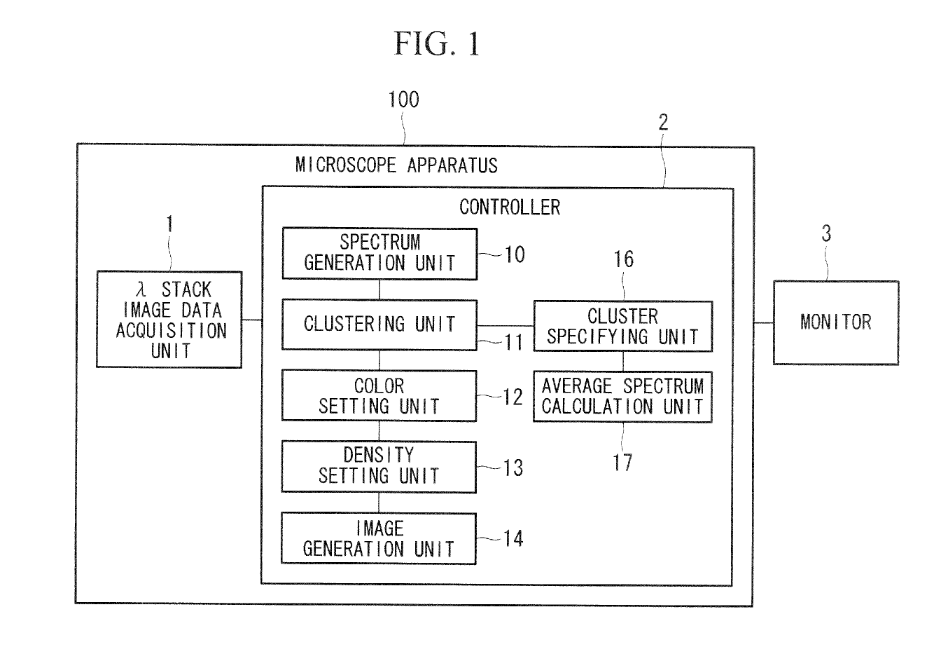

As illustrated in FIG. 1, a microscope apparatus 100 according to this embodiment includes a λ stack image data acquisition unit 1 and a controller 2.

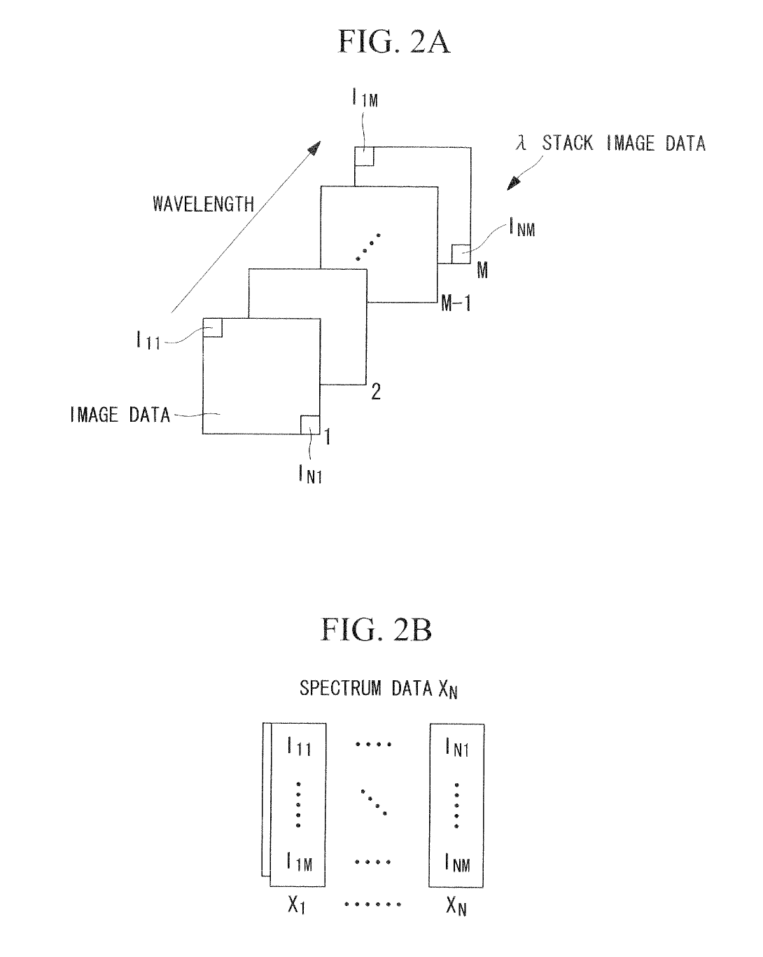

The λ stack image data acquisition unit 1 includes a light source (not illustrated) that applies excitation light to a sample including different kinds of fluorescent materials; a spectroscope (not illustrated) that separates the fluorescence emitted from the sample for each wavelength; and a detector (not illustrated) that detects, for each wavelength, the light separated by the spectroscope. The λ stack image data acquisition unit 1 acquires λ stack image data including a plurality of image data items for a plurality of different wavelengths in the same field of view. FIG. 2A illustrates a schematic view of the λ stack image data. As illustrated in FIG. 2A, assuming that the number of detected wavelengths is M, the term “λ stack image data” refers to an image data set including the number of image data items corresponding to the number M of wavelengths, and each image data included in the λ stack image data includes N pieces of pixel data I_{N}. Accordingly, in FIG. 2A, N-th pixel data having an M-th wavelength is represented by I_{NM} for convenience of explanation.

The controller 2 carries out a predetermined process on the λ stack image data acquired by the λ stack image data acquisition unit 1, to thereby generate an image for observing a sample. The controller 2 includes a spectrum generation unit 10, a clustering unit 11, a color setting unit 12, a density setting unit 13, and an image generation unit 14.

The spectrum generation unit 10 generates a spectrum for each pixel based on the λ stack image data. Specifically, as illustrated in FIG. 2B, spectrum data X corresponding to the spectrum for each pixel is generated for each pixel from each pixel data I_{NM} included in the λ stack image data. Accordingly, when the number of pixels is N, N pieces of spectrum data X_{NM} the number of which is the same as the number of pixels, and each spectrum data X_{N} includes pixel data I_{N1} to I_{NM} for each wavelength at the same coordinate position.

The clustering unit 11 performs clustering of the N pieces of spectrum data X_{N} generated by the spectrum generation unit 10, thereby classifying the spectrum data into a predetermined number K of clusters C_{K}. Here, the predetermined number K can be arbitrarily determined. Examples of the predetermined number may include the same number as the number of fluorescent materials coated on a sample, the number obtained by adding the number of backgrounds to the number of fluorescent materials, and the number of colors to be displayed on the image. This predetermined number K may be preliminarily determined or may be stored in the clustering unit 11. Alternatively, the predetermined number K may be determined in advance and input to the clustering unit 11 by a user every time an image is generated.

Note that the clustering can be carried out by a well-known method, such as EM algorithm or Bayes method, for use in a model created using a Kmeans method or a contaminated normal distribution, for example. Each spectrum data X_{N} is clustered according to a rule depending on the applied algorithm, that is, classified into K clusters. Accordingly, each spectrum data X_{N} included in each cluster C_{K} has characteristics common or similar to another.

The color setting unit 12 allocates and sets different colors to the K clusters C_{K}. Specifically, the pixels corresponding to the spectrum data X_{N} included in each cluster C_{K} are displayed with a color set by the color setting unit 12. Accordingly, assuming that K=3 holds, when red is set to the cluster C₁; green is set to the cluster C₂; and blue is set to the cluster C₃; for example, the pixels of the spectrum data X_{N} belonging to the cluster C₁ are displayed with red; the pixels of the spectrum data X_{N} belonging to the cluster C₂ are displayed with green; and the pixels of the spectrum data X_{N} belonging to the cluster C₃ are displayed with blue.

Note that the color for the cluster C₃ may be set according to a table indicating predetermined colors corresponding to the number of clusters preliminarily stored in the color setting unit 12, or may be set by a user by inputting a desired color each time.

The density setting unit 13 extracts a value of a maximum brightness from the spectrum data X_{N} of the pixels, for the pixels corresponding to the spectrum data X_{N} included in the cluster C_{K}, and sets the brightness of each pixel according to this value. Specifically, for example, when the cluster C₁ includes spectrum data X₈ of the eighth pixel, the value of the pixel data having the maximum brightness among the pixel data I₈₁ to I_{8N} included in the spectrum data X₈ is extracted and the brightness of the eighth pixel is set according to this value. The setting of the brightness of each pixel is carried out for all pixels of the spectrum data X_{N} included in the cluster C₁, to thereby recognize the contrast or gray scale of the pixels within the cluster C₁.

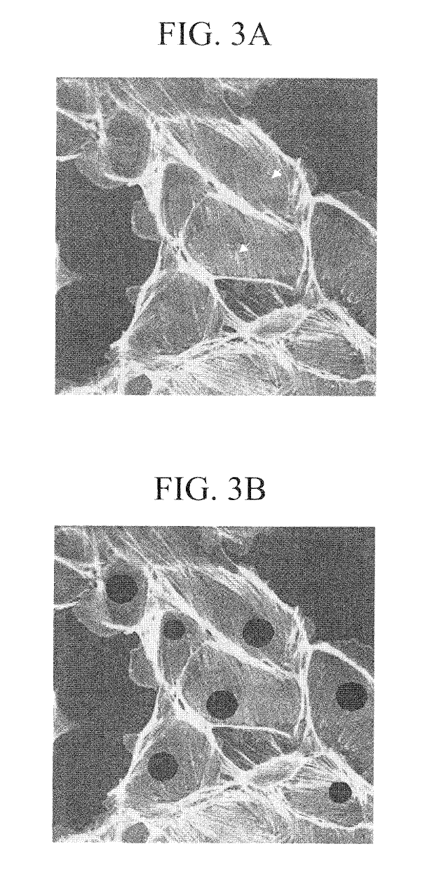

The image generation unit 14 displays the pixels included in each cluster with a color set by the color setting unit, thereby generating an image of a sample. At this time, when the brightness is set by the density setting unit to each pixel corresponding to the spectrum data X included in each cluster, an image also representing a brightness is generated. FIG. 3A illustrates the case where an image of a sample is generated with a single color without performing clustering by a known method. FIG. 3B illustrates the case where clustering is carried out according to this embodiment, and a color is set to each cluster C_{K}, to thereby generate an image of a sample.

To facilitate understanding of the invention, FIG. 3B clearly illustrates that respective areas belong to separate clusters. In fact, however, a plurality of clusters is mixed and present in the encircled areas illustrated in FIG. 3B. Unlike the conventional case in which pixels are displayed based only on the brightness, a plurality of color pixels is present in each encircled area in this embodiment. The image of the sample generated by the image generation unit 14 is output to the monitor 3 and is displayed on the monitor 3.

In some cases, the user tries to recognize the wavelength characteristics of a spectrum or the like in more detail for a specific cluster among the K clusters, for convenience of observation of the sample. Accordingly, the controller 2 includes a cluster specifying unit 16 that specifies any cluster C among the clusters C_{K}, and an average spectrum calculation unit 17 that calculates an average spectrum of the spectra for all pixels included in the specified cluster C.

The controller 2 outputs the spectrum data X included in the specified cluster C or the average spectrum calculated by the average spectrum calculation unit 17. The output spectrum data or average spectrum can be converted into numerical values or a graph to be displayed on the monitor 3 or stored in a memory (not illustrated) which is provided in or outside the controller 2.

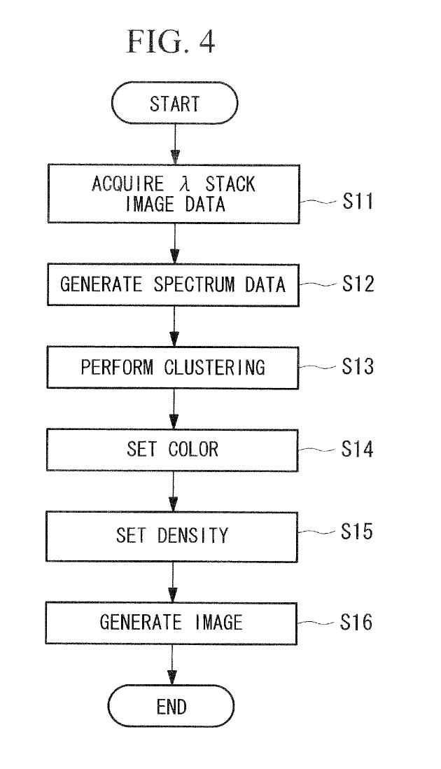

Hereinafter, a process for generating an image of a sample for use in observation in the microscope apparatus 100 described above will be described with reference to the flowchart of FIG. 4.

To generate the image of the sample, the λ stack image data including M image data items for each wavelength is acquired (step S11). Then, based on the λ stack image data, spectra for every N pixels, that is, N pieces of spectrum data X_{N} are generated (step S12), and the N pieces of spectrum data X_{N} are clustered according to a predetermined method, to thereby classify the data into K clusters C_{K} (step S13).

Further, different colors are allocated to each of the K clusters C_{K} (step S14). After that, the density of each pixel corresponding to the spectrum data X_{N} included in the cluster C_{K} is set to each cluster C_{K}. Specifically, the value of the maximum brightness is extracted from the spectrum data X_{N} of the pixels, for each pixel corresponding to the spectrum data X_{N} included in the cluster C_{K}, and the brightness of each pixel is set according to this value. The density setting is carried out for all the clusters C_{K} (step S15).

Then, when the pixels included in the cluster are displayed with the color set by the color setting unit and the brightness is set to each pixel corresponding to the spectrum data X included in each cluster, an image representing a gray scale according to the brightness set to the pixels within each cluster is generated (step S16), and the generated image of the sample is output to the monitor 3 and displayed on the monitor 3.

As described above, according to the microscope apparatus 100 according to this embodiment, the spectrum data indicating spectra for each pixel is generated based on the λ stack image data for each wavelength of light emitted from the sample. This enables recognition of the wavelength characteristics of each pixel and clarification of a difference in spectrum between pixels. The generated spectra for each pixel are clustered into a plurality of clusters. The clustering may be carried out by a well-known algorithm, such as a Kmeans method or Bayes method, for example, and the spectra for each pixel are clustered according to a rule depending on the applied algorithm, that is, classified into a plurality of clusters. Accordingly, the spectrum for each pixel included in each cluster has characteristics common or similar to another. In other words, the generated spectrum data is clustered into a plurality of clusters, thereby enabling classification of all pixels forming an image into a set (cluster) of pixels having common or similar wavelength characteristics. Further, different colors are set to the clusters and displayed, thereby enabling generation of an image displayed with a color according to the wavelength characteristics. Accordingly, even when the difference in density of the fluorescent materials in the sample is large, the distribution or gray scale of the fluorescent materials in the sample can be correctly recognized and the state of the desired tissue can be favorably observed.

Furthermore, the brightness of each pixel is set to each pixel included in the cluster according to the value of the maximum brightness among the spectrum data. This makes it possible to properly recognize the distribution or gray scale of the fluorescent materials in each cluster, and to favorably observe the state of the desired tissue in the sample.

Moreover, any cluster is specified as needed, and the spectrum data included in the specified cluster is output, thereby enabling recognition of the spectrum for each pixel included in the desired cluster. Accordingly, the characteristics of the cluster can be recognized in more detail, and the distribution or gray scale of the fluorescent materials in the cluster can be correctly recognized. At this time, the average spectrum of all spectrum data items included in the specified cluster is calculated and output. This enables recognition of the characteristics of the cluster in more detail.

Embodiments of the present invention have been described in detail above with reference to the drawings. The specific configuration of the invention is not limited to these embodiments. The present invention also includes design changes and the like without departing from the scope of the present invention.

### REFERENCE SIGNS LIST

1 λ STACK IMAGE DATA ACQUISITION UNIT
2 CONTROLLER
3 MONITOR
10 SPECTRUM GENERATION UNIT
11 CLUSTERING UNIT
12 COLOR SETTING UNIT
13 DENSITY SETTING UNIT
14 IMAGE GENERATION UNIT
16 CLUSTER SPECIFYING UNIT
17 AVERAGE SPECTRUM CALCULATION UNIT
100 MICROSCOPE APPARATUS

What is claimed is:

1. A microscope apparatus comprising:
a λ stack image data acquisition unit that detects light emitted from a sample for each wavelength to acquire λ stack image data including a plurality of image data items for a plurality of different wavelengths;
a spectrum generation unit that generates a spectrum for each pixel based on the λ stack image data;
a clustering unit that performs clustering of the spectrum for each pixel into a plurality of clusters;
a color setting unit that sets different colors to the respective clusters; and
an image generation unit that generates an image of the sample by displaying each pixel included in the clusters with a color set by the color setting unit.

2. The microscope apparatus according to claim 1, further comprising a density setting unit that sets, to each pixel included in the clusters, a brightness of each pixel according to a value of a maximum brightness among spectra for each pixel.

3. The microscope apparatus according to claim 1, further comprising:
a cluster specifying unit that specifies any cluster among the plurality of clusters; and
a spectrum output unit that outputs spectra for each pixel included in the cluster specified by the cluster specifying unit.

4. The microscope apparatus according to claim 2, further comprising:
a cluster specifying unit that specifies any cluster among the plurality of clusters; and
a spectrum output unit that outputs spectra for each pixel included in the cluster specified by the cluster specifying unit.

5. The microscope apparatus according to claim 3, further comprising an average spectrum calculation unit that calculates an average spectrum of the spectra for all pixels included in the cluster specified by the cluster specifying unit,
wherein the output unit outputs the average spectrum calculated by the average spectrum calculation unit.

6. The microscope apparatus according to claim 4, further comprising an average spectrum calculation unit that calculates an average spectrum of the spectra for all pixels included in the cluster specified by the cluster specifying unit,
wherein the output unit outputs the average spectrum calculated by the average spectrum calculation unit.
